(19) United States
(12) Patent Application Publication
(10) Pub. No.: US 2020/0323742 A1
(43) Pub. Date: Oct. 15, 2020

(54) HYGIENIC AND ORTHOTROPIC ORAL DEVICES

(71) Applicant: Nafys Samandari, Scottsdale, AZ (US)

(72) Inventor: Nafys Samandari, Scottsdale, AZ (US)

(21) Appl. No.: 16/711,128

(22) Filed: Dec. 11, 2019

Related U.S. Application Data
(63) Continuation of application No. 16/383,223, filed on Apr. 12, 2019, now Pat. No. 10,555,876.
(60) Provisional application No. 62/872,900, filed on Jul. 11, 2019.

(51) Int. Cl. A61J 17/00

(52) U.S. Cl. CPC A61J 17/001; A61J 17/008

(57) ABSTRACT

A hygienic oral pacification device includes a fluid-filled bladder. The bladder includes a nipple and alveolar ridge-mating flanges. The bladder is dynamically shaped and allows for pressures provided by the suckling child to re-shaping the bladder and flanges. A bite-block extends into the bladder to maintain a fluid path from nipple to flanges. As the child completes the suckling cycle, the bladder nipple is depressed and fluid is forced in the engorging flanges. The flanges thus cover the alveolar ridges and fill the vestibules. Further, a feed-bottle nipple includes an opening skirt to expand and rotate in the buccal vestibule. As the child completes the suckling cycle, the mouth portion is distorted, the skirt extended to provide cleaning, stimulation, and a bumper to deny extensive pronation. The flanges and skirt may be covered with a textured surface, or bristles, that provide mechanical brushing of oral surfaces.

### CLAIMS OF PRIORITY

The present continuation-in-part application includes subject matter disclosed in and claims priority to U.S. patent application Ser. No. 16/383,223 filed Apr. 12, 2019, entitled “Pacifier with Cleaning Brush,” and incorporated herein by reference, and also provisional patent application entitled “Improved Pacifier and Nipple” filed Jul. 11, 2019 and assigned Ser. No. 62/872,900, incorporated herein by reference, both which describe inventions made by the present inventor.

### BACKGROUND OF THE INVENTION

### 1. Field of the Invention

The present invention relates to the general art of oral care. The present invention more particularly relates to a pediatric dental oral hygiene and orthotropic development devices and uses thereof.

### 2. Description of Related Prior Art

Improvements to the BINKI BRUSH, or pacifier with cleaning brush, may be used on pacifiers, bottle nipples, or other devices intended for use in a mouth. Children from the age of zero to two years commonly use oral apparati, such as pacifiers, bottle nipples, teethers, etc. for numerous purposes. As may be understood from the name “pacifier”, the tool may be used to calm or soothe a child. Additionally, the tool may be used to exercise a child's tongue and cheek muscles, promote development of the maxilla, and otherwise serve to clean interior surfaces of the oral cavity via friction provided by the pacifier exterior surface(s). While newborns are often born without any erupted teeth, up to 15% of newborns in the United States have one or more teeth present. The “baby” tooth or teeth may be compromised due to decay caused by bacterial metabolic byproducts such as acids produced from substances in the oral cavity such as sugars present in milk, formula, or otherwise the tooth/teeth may be susceptible to damage from bacterial and fungal biofilms that may develop on the oral surfaces. It is therefore advantageous to include an oral apparatus that acts to clean, or otherwise brush, the upper and lower gingival ridges and/or erupted teeth. In addition, it has been shown that in the year 2014, approximately 40% of children under the age of 5 have some evidence of caries, often referred to as baby bottle caries.

Most oral apparati, such as pacifiers, binkies, soothies, etc., are often symmetrical. Oftentimes, a binky, or surrogate nipple, may be uniformly isometric, such as including a cylindrical nub with hemispherical cap (imitating a mother's biological nipple). Advanced oral devices may be transversely symmetrical, left to right, however, may include longitudinal shape changes such as alternating superior and inferior sides to better mimic the shape and location of the tongue, and the slight overbite of a baby, newborn, infant, or toddler. The promotion of an ideal orthotropic development of the maxillary and mandibular arches leads to the better development of the airway spaces, and this contributes to the prevention of multiple chronic maladies. As known in the field of orthotropics, deficiencies in airway spaces exacerbate these chronic conditions.

Prior attempts have been made to provide oral devices that achieve the dual purpose of pacification and oral hygiene, however, they suffer the drawbacks of improperly accounting for the changing shape of the mouth during the suckling exercise. Further, limited inventions have been directed to orthotropics and improvement of the development of the upper palate and/or mandible in the developing mouth. Nine out of ten children in the developed world may suffer some level of obstructive sleep apnea (OSA), including symptoms from sleep disorders, to breathing issues, to growth retardation.

It is therefore a primary object of the present invention to provide an oral device that provides for friction activated cleansing and/or stimulation of interior oral surfaces.

It is another object of the present invention to provide a pacifier to mate with at least one of the superior or inferior ridges (gingival and/or tooth).

It is yet another object of the present invention to foster proper development of the orthognathic relationship of the upper and lower jaw bones.

It is as yet a further object of the present invention to foster proper development of the upper palate and related bone structures.

It is a further object of the present invention to provide an easy to use oral device useful for babies and/or small children.

These and other objects of the present invention will become apparent to those skilled in the art as the description thereof proceeds.

### SUMMARY OF THE INVENTION

The present invention is directed to an oral device adapted to be partially inserted into the oral cavity. The present invention may take the form of a pacifier, bottle nipple, or otherwise. As a pacifier, the shield set on the outer surface of the lips, and the nipple, with flanges/wings emplaced within. When functioning as a bottle feed nipple, as single molded piece is preferred to fit over an open end of a bottle.

In the previous version, the upper portion of the intra oral device includes a preferably solid and/or flexible padding with one or more materials. Harder or thicker portions of the dome (or pads) will be separable, or at least change their relative orientation, as the central material stretches. A central bite block, as well as shield and/or cap may be made of one or more stiffer material(s). As the sucking motion is conducted, a tongue pressure pushes up on the bottom of the nipple (preferably at the tongue guide depression) and causes lateral stretching of the device. As the device is stretched, the harder/thicker portions at the top side resist stretching and are thus thrust against the upper palate and cause a slight upward and laterally outward force. The lower portion includes a tongue depression to better ensure proper alignment of device with the center of mouth and tongue. The outer surface of the device may include bristles, or a spiral shape for cleaning purposes, often as rubbed against surfaces of the mouth.

A nipple version of the present invention may include various undulations, and/or ribs, to cause proper turbulence of flowing fluids, to provide stimulation/cleaning to the oral surfaces, and to prevent vacuum seals on the mouth surfaces, and avoid hematomas. The angle of the pronation of the teeth and/or alveolar ridges is prevented from exceeding certain thresholds, e.g. 20% pronation that can cause adverse deformation of the malleable (growing) jaws. Further, the superior and inferior edges of the device, preferably at the collar, are offset with the superior set slightly (e.g. 1-3 mm) forward relative the inferior collar to promote proper orthotropic alignment of the maxilla and mandible relative the skull.

### BRIEF DESCRIPTION OF THE DRAWINGS

The present invention will be described with greater specificity and clarity with reference to the following drawings, in which:

FIG. 1 illustrates a side cross-sectional view of a bottle embodiment in passive state as applied into a human mouth.

FIG. 2 illustrates a side cross-sectional view of a bottle embodiment in a compressed state as applied into a human mouth.

FIG. 3 illustrates a side cross-sectional view of the mouth portion in passive state of a bottle embodiment of the present invention.

FIG. 4 illustrates a frontal view of a nipple in passive state of a bottle embodiment of the present invention.

FIG. 5 illustrates a side cross-sectional view of the mouth portion in compressed state of a bottle embodiment of the present invention.

FIG. 6 illustrates a frontal view of a nipple in compressed state of a bottle embodiment of the present invention.

FIG. 7 illustrates a top view of a mouth portion in passive state of a bottle embodiment of the present invention.

FIG. 8 illustrates a frontal view of a nipple and skirt in passive state of a bottle embodiment of the present invention.

FIG. 9 illustrates a cross-sectional side view of a skirt and collar in passive state a bottle embodiment of the present invention.

FIG. 10 illustrates a top view of a mouth portion in compressed state of a bottle embodiment of the present invention.

FIG. 11 illustrates a frontal view of a nipple and skirt in compressed state of a bottle embodiment of the present invention.

FIG. 12 illustrates a cross-sectional side view of a skirt and collar in compressed state a bottle embodiment of the present invention.

FIG. 13 illustrates a side view of a bottle embodiment of the present invention.

FIG. 14 illustrates a perspective view of a bottle embodiment of the present invention.

FIG. 15 illustrates a top view of a mouth portion of a bottle embodiment of the present invention.

FIG. 16 illustrates a frontal view of a mouth portion of a bottle embodiment of the present invention.

FIG. 17 illustrates a bottom view of a mouth portion of a bottle embodiment of the present invention.

FIG. 18 illustrates a perspective view of a mouth portion of a bottle embodiment of the present invention.

FIG. 19 illustrates a side cross-section view along lines A-A of FIG. 16.

FIG. 20 illustrates a side cross-section view along lines B-B of FIG. 16.

FIG. 21 illustrates a side cross-section view along lines BB of FIG. 16 as when the mouth portion is in a compressed state.

FIG. 22 illustrates a side view of a mouth portion of a bottle embodiment of the present invention.

FIG. 23 illustrates a front cross-sectional view along lines C-C of FIG. 22 in passive state.

FIG. 24 illustrates a front cross-sectional view along lines C-C of FIG. 22 in compressed state.

FIG. 25 illustrates a side cross-sectional view of a bottle embodiment in compressed state with force vectors of flow and external pressures.

FIG. 26 illustrates a front view of a bottle embodiment in passive state.

FIG. 27 illustrates a partial transparent side perspective view of an alternative bottle embodiment in passive state as applied into a human mouth.

FIG. 28 illustrates a side cross-sectional view of a bottle embodiment in passive state.

FIG. 28A illustrates a side cross-sectional view of a bottle embodiment in passive state.

FIG. 28B illustrates a side cross-sectional view of a bottle embodiment in compressed state.

FIG. 29 illustrates a perspective view of a pacifier embodiment of the present invention.

FIG. 30 illustrates a perspective exploded view of a pacifier embodiment of the present invention.

FIG. 31 illustrates a side view of a pacifier embodiment of the present invention.

FIG. 32 illustrates a top view of a pacifier embodiment of the present invention.

FIG. 33 illustrates a front view of a pacifier embodiment of the present invention.

FIG. 34 illustrates a cross-sectional side view along lines C-C of FIG. 33.

FIG. 35 illustrates a cross-sectional side view along lines B-B of FIG. 32 in passive state.

FIG. 36 illustrates a cross-sectional side view along lines B-B of FIG. 33 in compressed state.

FIG. 37 illustrates a top view of an alternative pacifier embodiment of the present invention.

FIG. 38 illustrates a cross-sectional side view along lines A-A of FIG. 32.

FIG. 39 illustrates a cross-sectional side view along lines A-A of FIG. 37 in passive state.

FIG. 40 illustrates a cross-sectional side view along lines A-A of FIG. 37 in compressed state.

FIG. 41 illustrates a cross-sectional side view along lines A-A of FIG. 32 in passive state.

FIG. 42 illustrates a cross-sectional side view along lines A-A of FIG. 32 in compressed state.

FIG. 43 illustrates a top view of an alternative bite block of the present invention.

FIG. 44 illustrates a top view of an alternative bite block of the present invention.

FIG. 45 illustrates a top view of an alternative bite block of the present invention.

FIG. 46 illustrates a top view of an alternative bite block of the present invention.

FIG. 47 illustrates a top view of an alternative bite block of the present invention.

FIG. 48 illustrates a top view of an alternative bite block of the present invention.

FIG. 49 illustrates a top view of an alternative bite block of the present invention.

FIG. 50 illustrates a side cross-sectional view of a pacifier embodiment of the present invention.

FIG. 51 illustrates a cross-sectional view of a pacifier embodiment of the present invention.

FIG. 52 illustrates a cross-sectional view of flanges along plane lines F-F in FIG. 51.

FIG. 53 illustrates a cross-sectional view of flanges along plane lines E-E in FIG. 52.

### DETAILED DESCRIPTION OF THE PREFERRED EMBODIMENTS

With use of embodiments of the present invention, one may provide hygienic and/or orthotropic support to newborns, infants, children, adolescents (or even adults). The present invention maybe used to prevent adverse deformation of the tissues and bones associated with the mouth. When used in newborns and infants, the application of orthotropic devices can guide the eruption of teeth and position and orient the bones in an ideal position. Further, via application of rhythmic vibrational signaling, stem cells can be activated, and causing phenotype improvements via epigenetic expression guided via external stimulation of the genotype. Rhythmic vibrational signaling can increase or induce stem cell development in the area of the signal.

Proper orthotropic development may also have multiple other pathways for providing a healthier human, both aesthetically and for health factors. Obstructive sleep apnea affects millions of people of all ages. In children symptoms can range from bed wetting, choking, drooling, coughing, night sweats, behavioral problem, learning disabilities, sluggishness, snoring, teeth grinding, restlessness, attention deficit hyperactivity disorder (ADD or ADHD).

By forming an orthotropically aligned mouth (maxilla and mandible), a root cause of obstructive sleep apnea (OSA) can be minimized, controlled, or even eliminated. With the present invention and embodiments thereof, we may control or prevent these chronic and debilitating diseases.

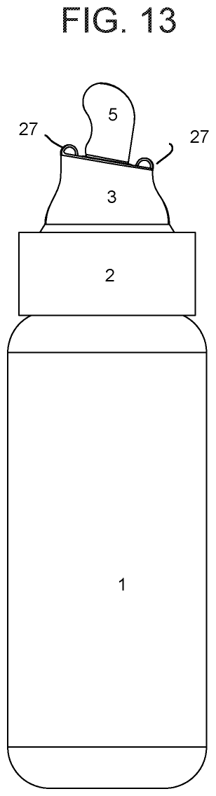

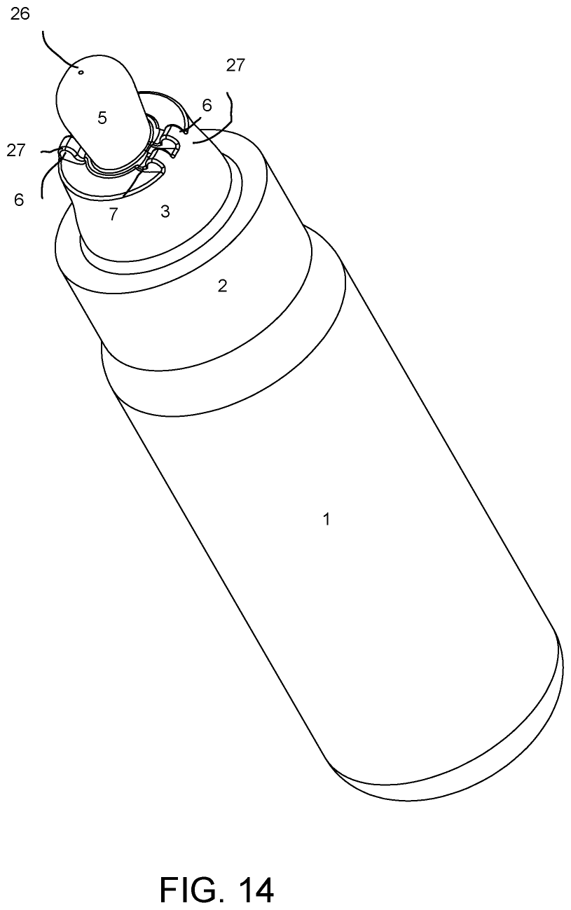

As can be seen in FIGS. 13-15, bottle 1 may be equipped with cap 2. Bottle 1 is shown with cap 2. Mouth portion 3 is set thereon, and includes skirt 27 and nipple 5. Cap 2 may be threadedly engaged to screw onto bottle 1. Mouth portion 3, fits onto cap 2, preferably via a channel lip fastening connection. It is preferable that cap may be removed from bottle via unscrewing, and nipple may be removed from cap, to facilitate cleaning of the bottle and components. Cap is preferably made of a hard plastic, while nipple is preferably made of a softer plastic, silicon, silicone, or other known material for nipples, bottles, and pacifiers. Nipple 5 may include air vent 29, preferably set outside area of lips when in use.

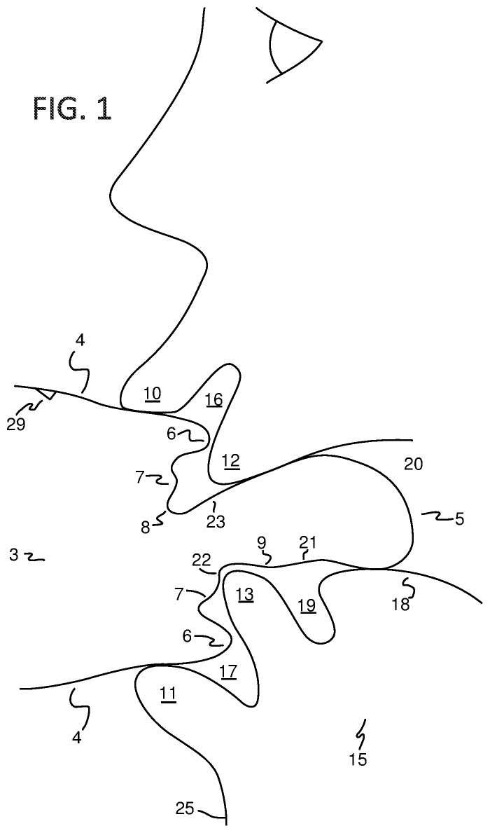

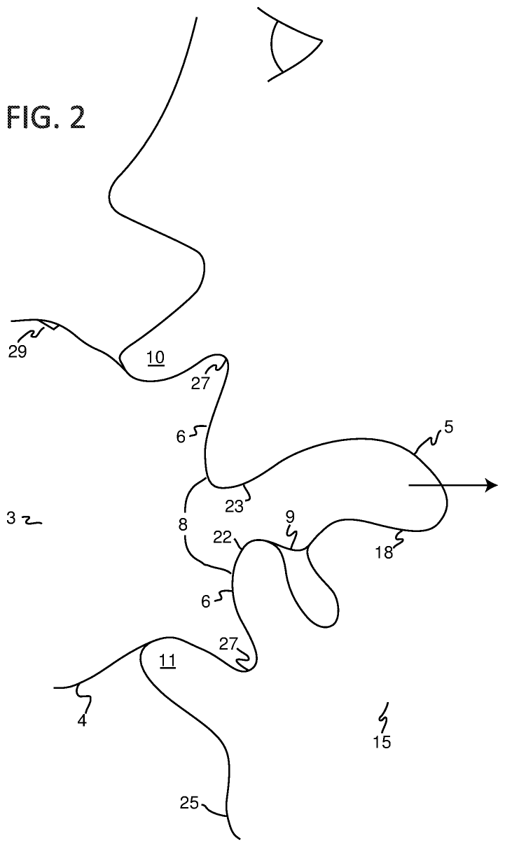

With reference to bottle mouth portion 3 in use with a human mouth, FIGS. 1-2 demonstrate two states of action. FIG. 1 demonstrate the mouth portion 3, including skirt 27 and nipple 5 applied to a human mouth prior to application of compressive forces. This is termed the passive state, as with equilibrium forces within and outside the mouth portion, the structure, shape, and orientation remain in passive form. Upper lip 10 and lower lip 11 of the user may fit onto neck 4 as a lip hold along mouth portion of nipple. Major undulations 6 may be provided opposite bottle along neck 4. Major undulations, including both superior major undulation and inferior major undulation 6A and 6B, are preferably set to fit into the maxillary buccal vestibule 16 and mandibular buccal vestibule 17, respectively. Minor undulations 7, fit along/between major undulations (as shown) and join with the main nipple 5 at collar 8. Together, the major and minor undulations form ribs.

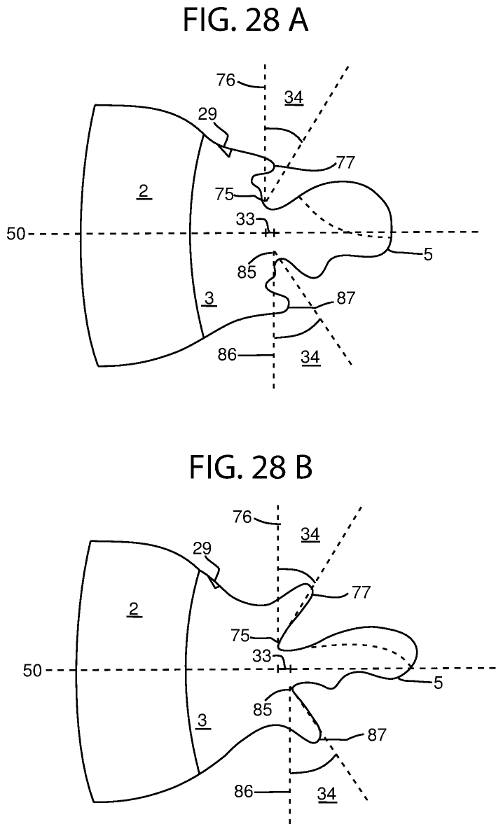

When sucking, ribs encourage turbulence of fluid flowing within mouth part, and further prevent vacuum seal against oral surfaces. Ribs further allow expansion of the flanges (undulations) into the collar to fill in portions of the vestibules. Ribs, allow for mechanical cleaning of gums. Micro movements of the ribs may cause a rhythmic vibration, and vibrational signaling, on the oral surfaces to stimulate vascular development, tooth growth, and stem cell growth in the bony membrane and bone development/production. Ribs may form a skirt 27, while major undulations help define a skirt edge 47, that provides for a bumper to prevent excess pronation of the alveolar ridges to go beyond twenty-degrees from vertical axis 30 (or seventy degrees from horizontal plane 50). Vertical axis 30 and horizontal plane 50 meet at vertex 55, while skirt 27 is intended to roughly rotate along vertex from a more acute angle, as shown below in FIG. 28A, to the wider acute angle, as shown below in FIG. 28B, when exposed to compressive forces to achieve the compressed state (discussed below with reference to FIG. 2). Mandible 15 may be enclosed around nipple for use of bottle. User chin 25 is shown. Nipple 5 may include milk pore 26 at the proximal end of nipple. Milk pore can be one or more apertures in the nipple, dependent on the needed flow rate for feeding in relation to the age/size of infant/user.

As between undulations and nipple, a collar 8 is formed. Collar 8 provides placement for maxillary alveolar ridge and mandibular alveolar ridge, respectively. Maxillary alveolar ridge 12 fits onto superior nipple collar, while mandibular alveolar ridge 13 fits into inferior nipple collar. An inferior lingual ridge 9 may be set as between the undulations and a depressed tongue guide 21. Tongue guide 21 provides for a depression to locate tongue 18. Tongue guide also causes tongue to provide upward force against maxilla, and otherwise exercise and develop habits to strengthen and encourage proper tongue placement when not feeding/using device, and trains the tongue positioning from an early age. Nipple 5 fits into vault 20 of user's mouth.

As seen in FIG. 2, the sucking action caused deformation of mouth portion 80 into a compressed state. Force vectors are shown via arrows. Lips 10 and 11 press, or otherwise provide push vector compressive forces against superior and inferior neck 4, respectively (neck 4 providing a lip hold). Upper and lower skirt, 77 and 87, expand, rotate, and move to fill maxillary and mandibular buccal vestibules, 16 and 17. Maxillary alveolar ridge 12 and mandibular alveolar ridge 13 engage collar 8 to bite down onto mouth portion 3. Tongue 18 thither presses upwards and anteriorly into tongue depression guide 21 to press on, or squeeze, nipple 5. When feeding, the mouth serves to suck on nipple in a posterior direction (e.g. as when feeding) to pull nipple. As mouth portion is deformed, nipple 5 extends posteriorly, and skirt 27 extends outwardly.

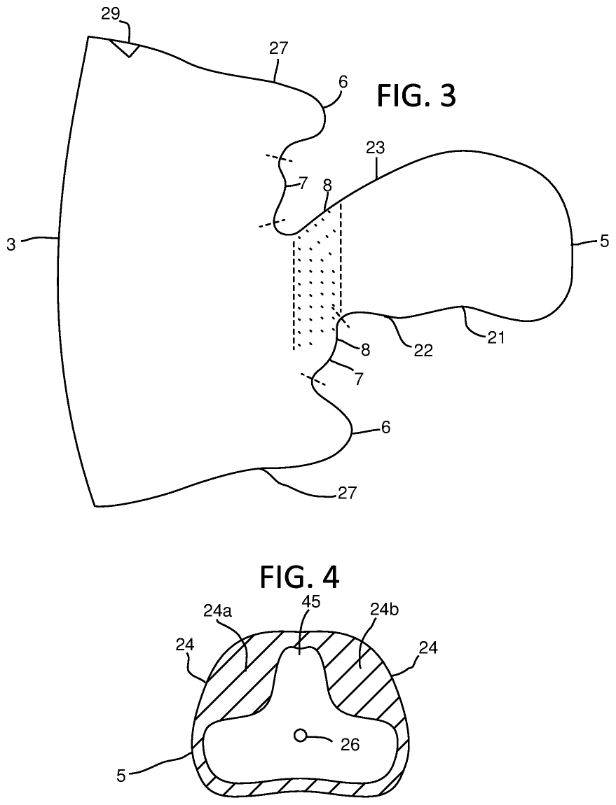

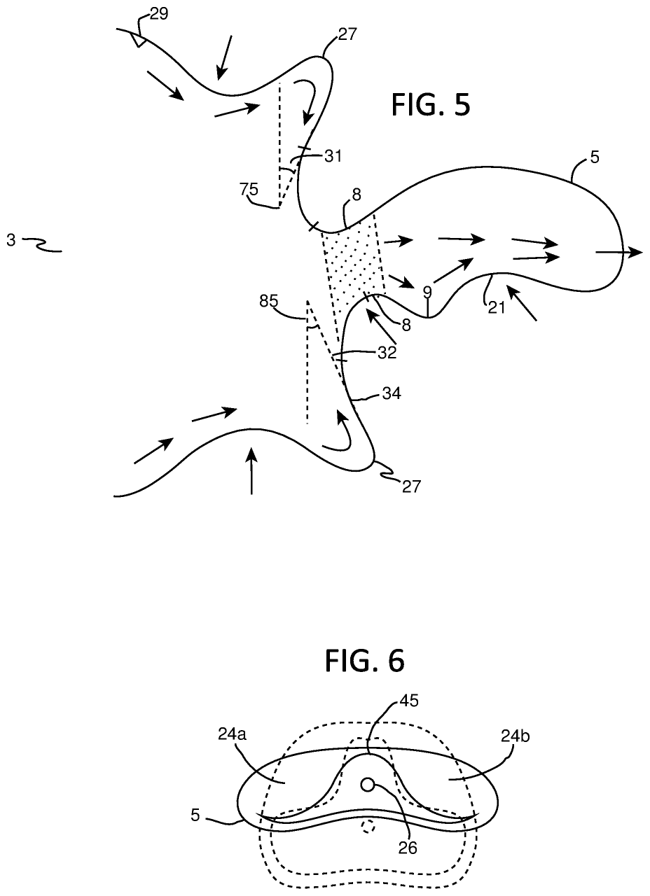

As can be seen in FIGS. 3-6, mouth portion 3 in passive (non-compressed) state is shown in FIGS. 3-4, while in compressed state in FIGS. 5-6. Air vent 29 is set along neck 4 in proximity to cap 2 (not shown). Major undulations 6 are shown extending at offset extending lengths, with minor undulations 7 set between major undulations 6 and collar 8. As is shown, superior and inferior collars 8 are offset by linear offset 33 which may be as much as 1-3 millimeters to from an orthotropic collar to guide jaw relationships, to optimize positioning as known in natural breast feeding, and facilitate proper orthotropic jaw development. It is contemplated that positioning the superior maxilla, forward by 1-3 millimeters in relation to the inferior mandible, proper alignment of the jaw will be formed.

As can be seen in FIGS. 28, 28A and 28B, vertical axis 30 designates a twenty-degree angular offset above 31 and below 32, and horizontal plane 50 designates a seventy-degree offset, as the threshold angle to which the pronating alveolar ridge is abutted and stopped from further pronation. It is contemplated that the angle of the alveolar ridges when engaging the collars will limit the forward pronating angle to twenty degrees as is shown in angle 34. The angle of twenty degrees from vertical, or seventy degrees from horizontal, is preferred as the maximum orthotropic angle for forward extension of the alveolar ridges and teeth as they emerge. This is in contrast to development of pronate teeth caused by thumbsucking, etc. as is known in the art of pediatric orthodontics. Angles less than twenty degrees are preferable, while an angle between fifteen and twenty degrees is most preferable. Angles beyond twenty degrees would indicate excessive pronate tooth/ridge growth and is prevented by the extending undulations.

FIGS. 28A-28B demonstrate an alternative embodiment of the present invention. In passive state, as shown in FIG. 28A, skirt 27 forms a more acute angle. Additionally, collar 8 is offset at a lower length of approximately 0-1 mm. As mouth portion 3 is exposed to compression forces, skirt 27 expands as minor undulations 7 flatten out to allow major undulations 6 to rotate and extend (so as to fill buccal vestibule). Skirt may be outfitted with surface features. Skirt 27 includes upper skirt 77, which extends to an angle of approximately twenty degrees from vertical, as defined from upper vertex 75 defining an upper vertical axis 76, and lower skirt 87, which extends to an angle of approximately twenty degrees from vertical, as defined from lower vertex 85 defining a lower vertical axis 86.

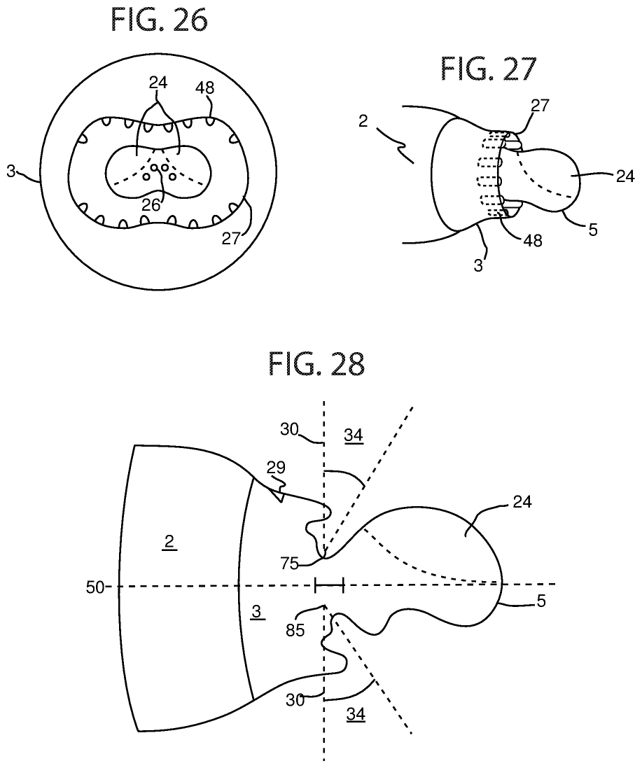

Referring to FIGS. 26-27 frenum relief 28 is shown, the device including both superior and inferior frenum reliefs 28. Major undulation 6 are shown as are minor undulation 7, to form ribs 48.

Referring to FIGS. 4 and 6, nipple 5 may include obstructive sleep apnea (OSA) pads 24. OSA pads 24, both right 24a and left 24b, are adapted to engage the maxilla of the user mouth, and apply small forces to achieve ideal orthotropic growth of maxilla. Internal padding of OSA pads provide for superior and lateral forces when engaging maxilla, and provide treatment for maxillary bone development to reduce risk and effects a obstructive sleep apnea.

OSA pads 24 may include two separate pads, as shown, and milk pore 26 may include one or more holes, or separate openings, to allow for fluid passage from bottle through nipple. OSA pads 24 are preferably thicker pads that allow lateral expansion to aid in orthotropic development of the maxilla and nasal floor. OSA pads 24 press and separate to force expansion of the maxilla. Employing lateral outward pressure on the maxilla, encourages broadening the maxilla, thus causing opening the floor of the nose. This well-developed maxilla and nasal floor provide proper aeration through the nostrils, and increases ventilation through the nose to decrease harmful issues associated with asthma and allergies. Nose breathing helps warm incoming air, filter the air, and mixes nitric oxide (a potent vasodilator) to be received by the alveoli in the lungs. This in turn causes better oxygen absorption and raises oxygen saturation in the blood. Further, with proper stretching/growth of the appropriately widened maxilla through orthotropics, the mandible will be induced to expand to a proper width as well in accordance with widening of upper teeth/ridge in maxilla. Further information on the proper development of the maxilla, oral and nasal structures can be found in article entitled Is it Mental or Dental? Cranial & Dental Impacts on Total Health by Dr. Raymond Silkman, DDS, published Mar. 30, 2006, published by the Weston A. Price Foundation, attached and incorporate by reference. Major undulations 6 provide for a skirt 24 surrounding nipple. Compressive forces applied (by the mouth) force down on roof of nipple as the infant feed. Compressive forces are also applied to the inferior side by the infant's tongue, and fluid is forced from pore. Superior and lateral forces on nipple/mouth portion are applied to create maxillary orthotropic forces in resistance via OSA pads, and guide better maxillary bone development. The proper bone development reduces the risk of OSA. (Note: passive state shape is shown in broken lines to mark dynamic change in mouth portion shape.)

As can be seen in FIG. 3, mouth portion 3 is shown. Air vent 29 is preferably placed on superior side on the anterior edge of mouth portion 3, near where mouth portion meets cap. Minor undulations 7 provide for a zone of undulation that can stretch or otherwise add to turbulence of flowing fluid. Nipple 5 extends posteriorly from orthotropic collar 8, and further include tongue guide 21. Collar 8 includes an offset, whereby skirt superior rib 48a is set forward (or anterior), approximately 1-3 mm relative skirt inferior rib 48b. The offset of the collar and ribs is associated with proper orthognathic alignment of the jaw.

As can be seen in FIG. 5, a fluid How design is shown. Multiple force vectors induce distortion and migration of major undulations 6 to create flaps that fill the maxillary and mandibular buccal vestibules. Air vent 29 is set outside of user lip to allow a one-way valve flow of air into the bottle so as to prevent vacuum within the bottle. Air vent is positioned in a manner that is shall be preferably on the superior side of nipple, but may be on the inferior side. Both push and pull force vectors impact the mouth portion and nipple. Push forces are provided by the compressive motions, such as lips pursing and alveolar ridges/teeth biting against the upper and lower portions of the device. Further, the tongue pressing upwards causes a push force vector against the nipple, further distorting the shape. Pull vectors are provided by the sucking and vacuum forces that draw fluid from the bottle through the pores and air into the vent. Further, pull vectors cause the nipple to extrude in a posterior direction, and may meet the roof of the mouth vault.

It is preferable that the one-way valve prevents fluid exiting air vent. As the force vectors engage the nipple, the lips purse against collars 8 to squeeze nipples at neck 4. Further, maxillary and mandibular alveolar ridges engage collar 8 to further squeeze nipple. Finally, sucking force induces a pull or vector force towards the throat. Sucking is supported by tongue thrust from tongue 18, preferably at tongue guide 21 on the inferior side of nipple. OSA pads 24 are forced up against the maxilla. Fluid flows out of bottle and through milk pores 26. The path of flow is guided via the shape of the nipple as it is deformed. Undulations 8 extend into vestibules causing a broadening of the nipple. Fluid flows from bottle into undulations and causes turbulence within undulations. This turbulence is preferred to prevent solids from forming, and otherwise as a hygienic cleaning function to prevent buildup of residue, or otherwise stagnant fluid. As the undulations are flushed, fluid continues to flow into nipple, in turbulent fashion until reaching release at milk pore 26. Both the repetitive swallow action and rhythmic vibrational signaling induce stem cell activity.

As can be seen in FIG. 6, major undulations 6 form a skirt 41. Nipple 5 includes tongue depression guide. Here, the mouth portion is shown in full including air vent 29 and channel 39. Channel is set to allow screw cap 2 (not shown) to fit via fastening method over mouth portion. Preferably, cap includes an extending interior flange to fit into channel, while mouth portion is made of a flexible material that can squeeze into cap. OSA pads 24a and 24b are set with a superior cleft 45 set therebetween. OSA pads are preferably of a thicker material, and cleft allows for relative movement of OSA pads to deform flex and bend as the nipple is deformed under pressure. Tongue depression guide 21 is shown along with a single milk pore. The clefting of the internal OSA pads will, upon tongue compression, cause lateral and superior loading of the two maxillary membranous bony plates.

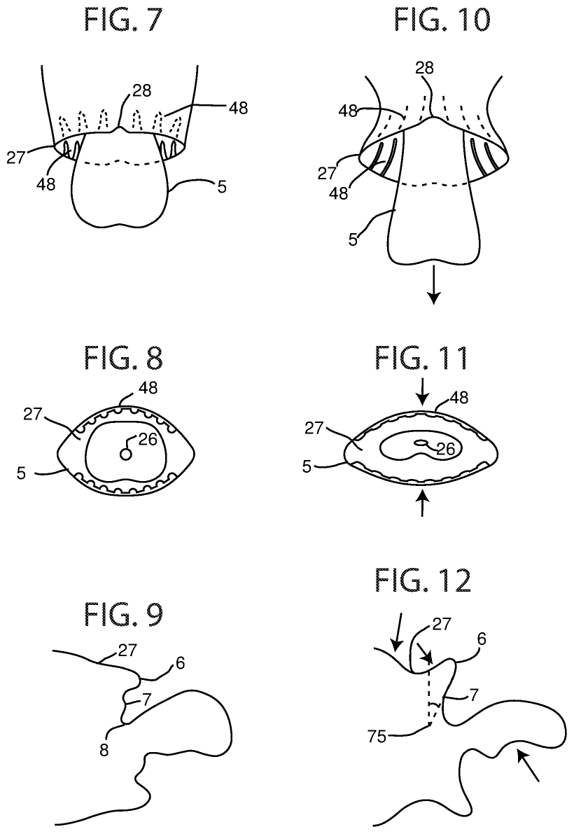

Various shapes of the mouth portion 3 are shown in FIGS. 7-12. FIGS. 7-9 show the mouth portion in passive state (when equilibrium forces are set upon system). Skirt 27 include frenum relief 28 to engage with the user's mouth. Here' skirt 27 is closed, and nipple 5 is intruded. Major undulations 6 form skirt 27. Major undulations 6 and minor undulations 7 forms ribs 48. Skirt forms a high angle. FIGS. 10-12 show the system in compressed form. Nipple 5 is extended (posteriorly) forced by compressive forces and/or sucking vacuum (pull) forces. Skirt 27 flares out as neck 4 is squeezed by lips to provide lateral opening of skirt. Nipple 5 stretches and extrudes. Ribs 48 are also stretched and reach a low angle profile. When ribs and skirt flare out, skirt fills buccal vestibule. Skirt increases in height, narrows (as minor undulations flatten), and turns upright. Skirt 27 also provides a bumper of sort to help guide orthotropic angle of alveolar ridge—preventing excessive pronation.

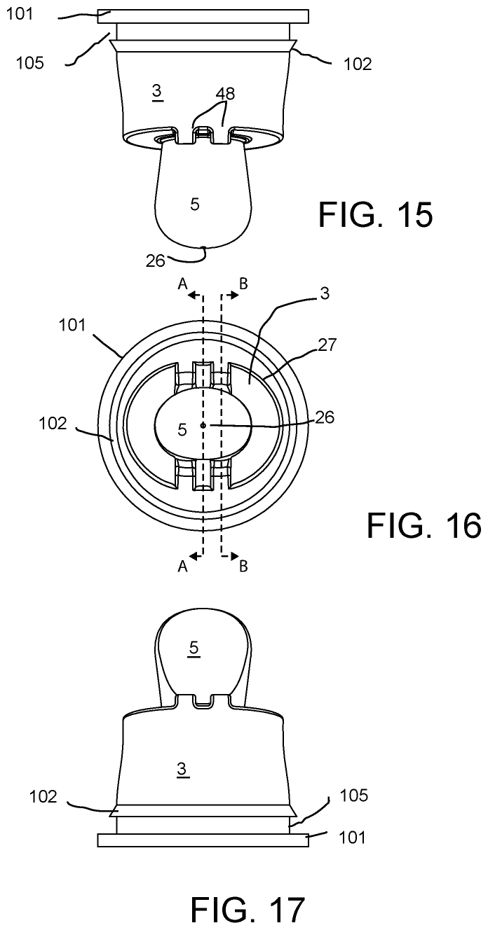

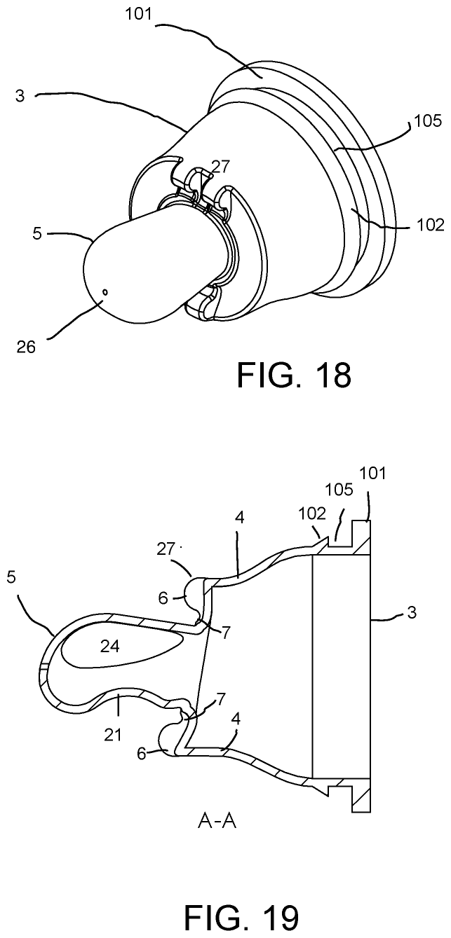

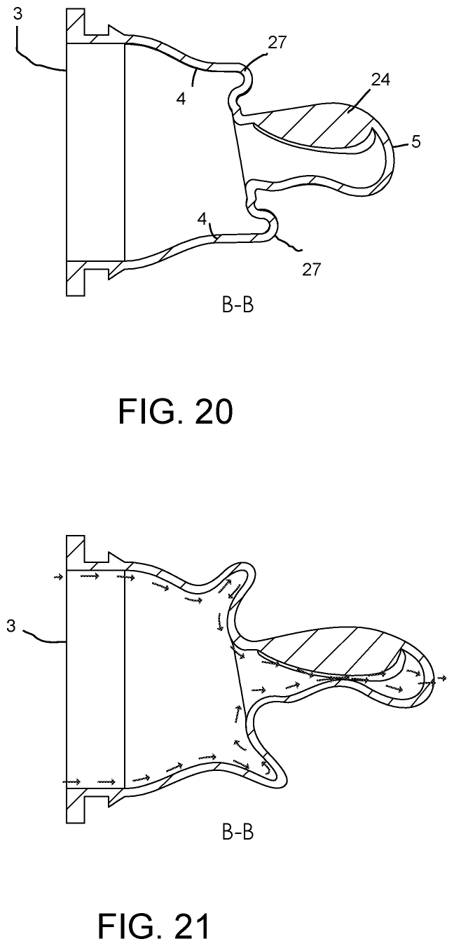

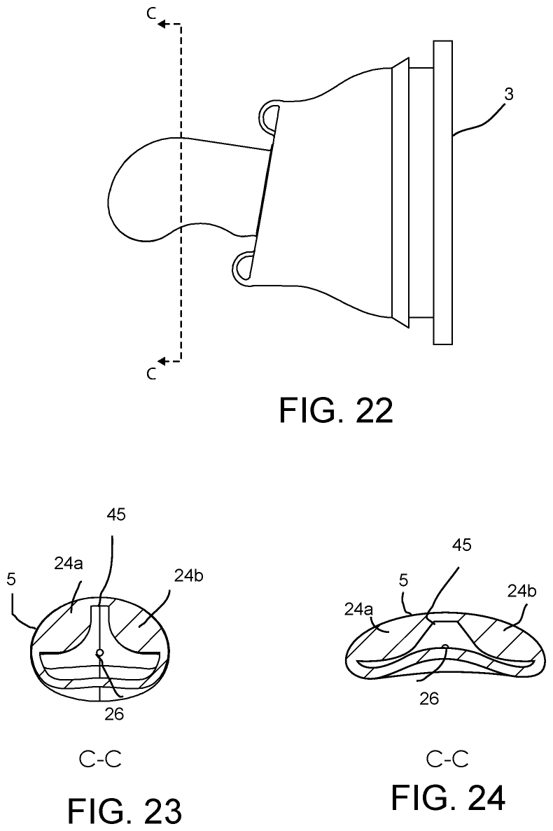

Mouth portion 3 is shown in isolation for further detail of an embodiment of the present invention in FIGS. 15-24. Mouth portion 3 includes circumferential features on anterior side, including edge flange 101 and secondary flange 102 forming channel 105. Channel 105 mates with interior flange in cap (not shown) to provide a flexible, yet water-tight seal when mouth portion applied to cap. Skirt 27 forms with major undulations 6. It is preferred that an even number of major undulations 6, and ribs 48, are formed with a center gap 46 set therebetween on both superior and inferior sides. Nipple 5 includes pore 26, or pores in alternative embodiments. Skirt 27 defines side edges 47, absent of undulations. Nipple 5 includes tongue depression guide 21 on the underside of nipple. Further, OSA pads 24 are set preferably within (as shown, or part of the features of the nipple shell, or less preferably on the exterior surface of nipple shell (not shown)). As shown in FIG. 23-24, nipple 5 moves from passive state (FIG. 23) to compressed state (FIG. 24). Tongue guide 21 is forced upwards and further distorts nipple to cause OSA pads 24a and 24b apart. (Superior) cleft 45 allows for mechanical separation and rotation of OSA pads. As shown in FIG. 21, fluid flow path is indicated by arrows, fluid entering mouth portion 3, passing through skirt (causing interior flushing/cleaning and causing vibrations) around OSA pad 24 and out pore 26.

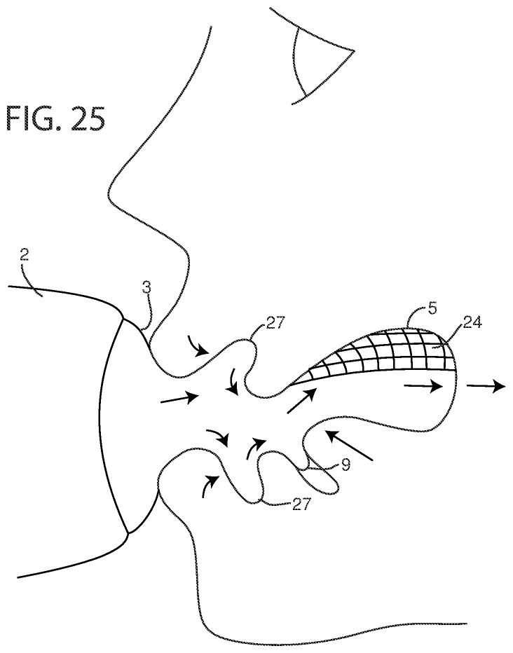

FIG. 25 further demonstrated the multiple force vectors caused when in use by user's mouth to distort and reshape mouth portion 3 on cap 2. Force vectors induce distortion and migration of skirt (or flaps) and also produce turbulence of flow through mouth portion 3. Pursing of lips 10 and 11 around neck 4 cause compressive force. Alveolar ridges 12 and 13 bite down on collar 8. Tongue 18 provide thrust up against tongue guide 21 and compresses against maxilla vault 20.

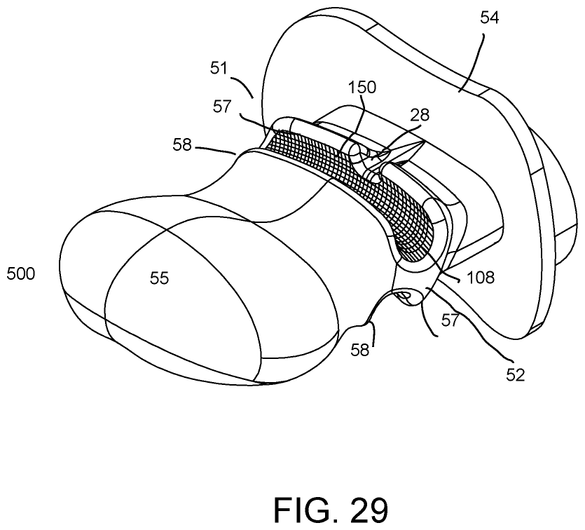

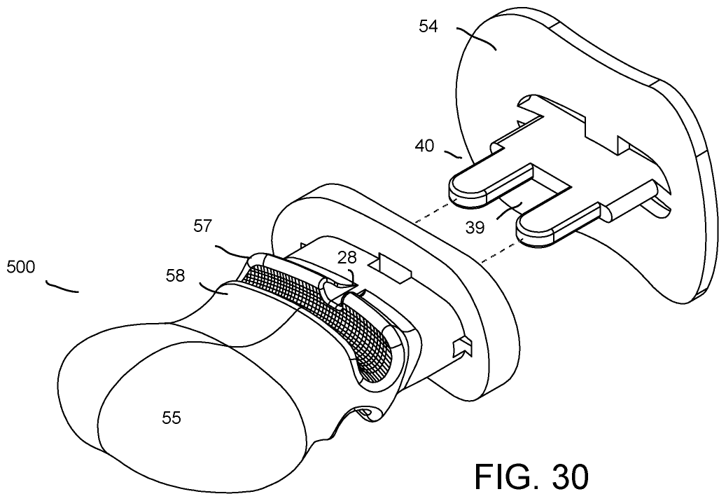

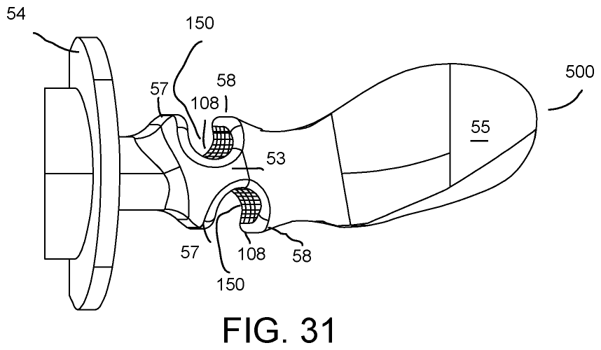

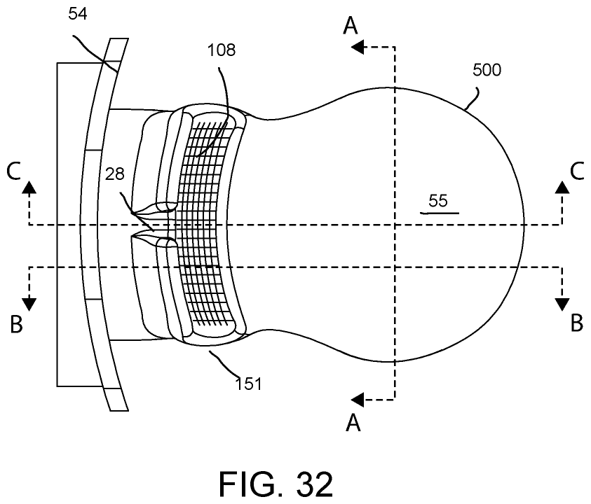

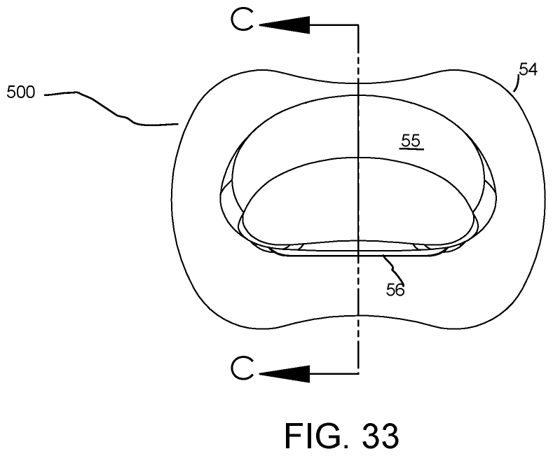

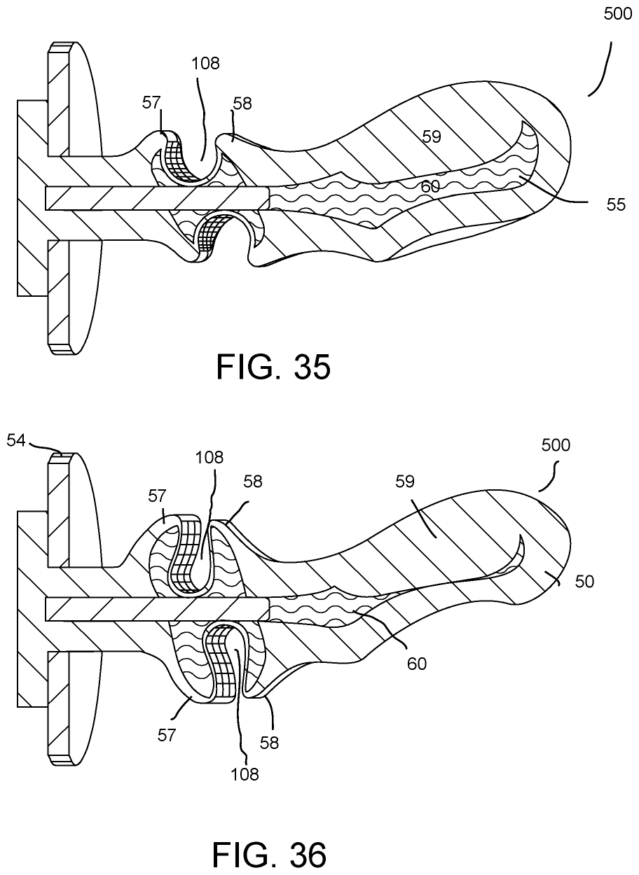

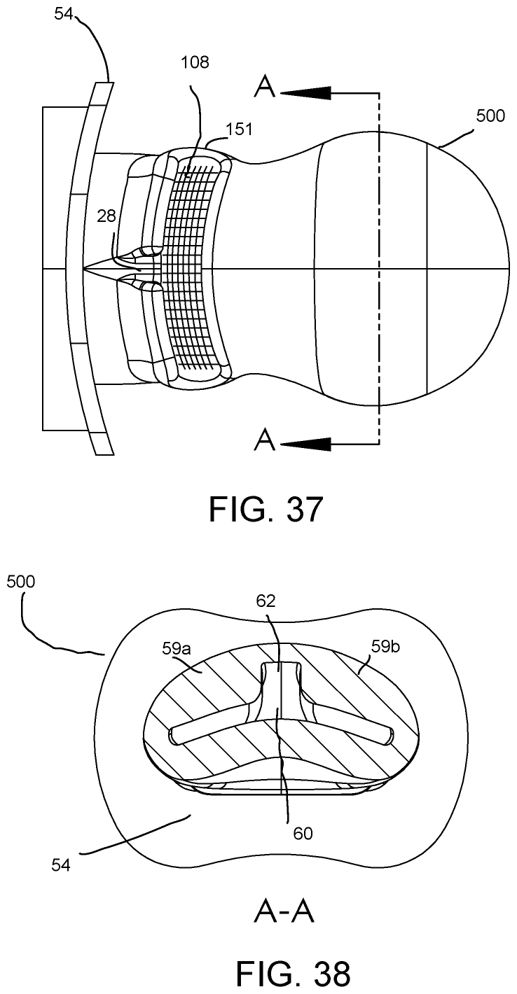

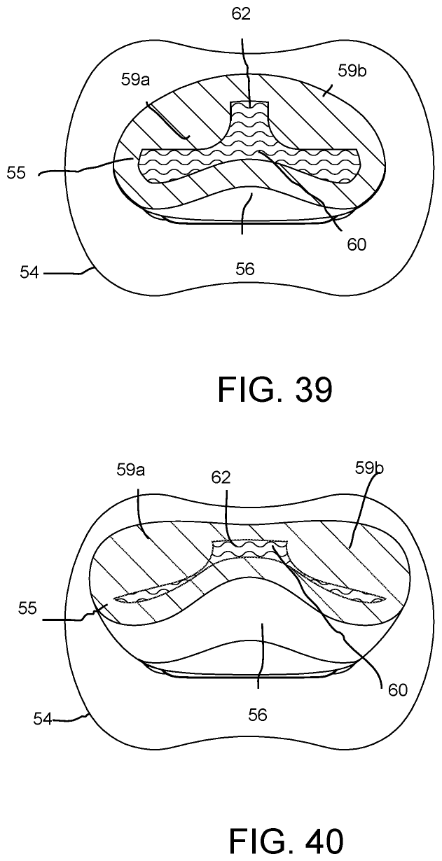

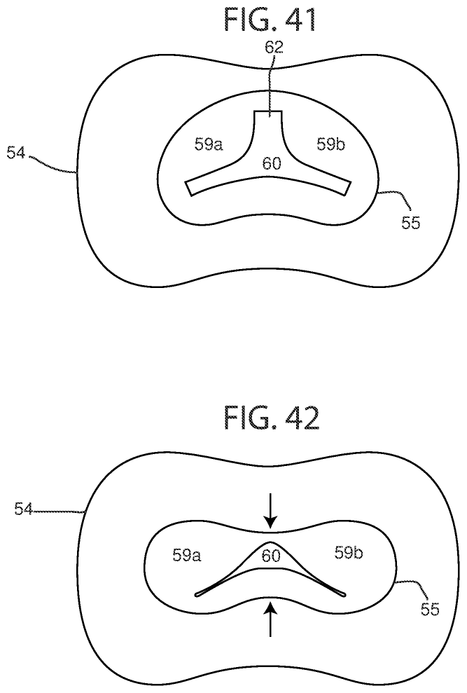

Pacifier embodiments of the present invention are shown in FIGS. 29-42. Pacifier 500 includes superior collar 51 and inferior collar 52. A side wall 53 may separate superior and inferior collars. Shield 54 is shown as is known in the an to engage with the outer lip of user. Nipple 55 extends to the distal end, and may include a tongue depression 56. Flanges 57 and wings 58 are set on the upper and lower portion of the pacifier. Further, maxillary frenum indentation may be set along the center line to allow for relief for the frenum. As between flanges and wings, a textured surface 150 is placed and intended to make contact with alveolar ridges and otherwise contact vestibules for hygienic, cleaning, and stimulation. Texture provides for cleaning, and stimulation of the gums and alveolar ridges. In a similar manner, in the bottle embodiment, vibrational forces by flow cause undulations to stimulate the vestibules and alveolar ridges. OSA pads 59 may be set on the superior side of nipple, opposite tongue depression 56. Cleft, or ceiling gap 62 is set as between OSA pads 59a and 59b. Frenum relief 28 maybe present on superior and inferior sides. Collar 108 is set on both superior and inferior sides between flanges 57 and wings 58, with sides 151 set on each side. Flanges (and wings) are adapted to bulge and extend when fluid from nipple 55 passes into flanges. As seen in FIG. 30, shield 54 is connect to bite block 40 with channel 39 set therein to allow for fluid flow from nipple 55 into flanges 57.

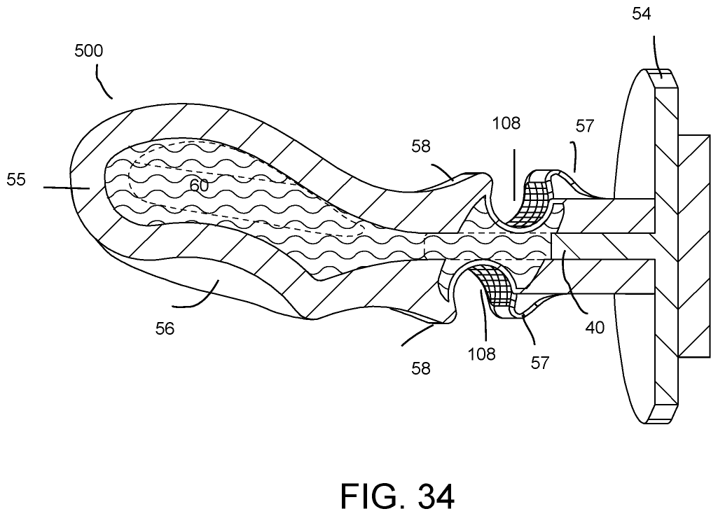

As can be seen in cross-sectional view FIGS. 34-36, nipple 55 includes OSA pads 59 on right and left side with central ceiling gap 62 set therebetween within cavity 60. Pacifier is preferably hollow, or filled with a fluid, or gas, or otherwise within cavity. As the nipple is under pressure, the nipple collapses forcing fluid in cavity to extend into flanges, and in some embodiments, wings. OSA pads move relative to one another and exert pressure against maxilla. It is preferable that the interior side of OSA Pads 59 include a filleted edge with rounded corners.

Nipple 55 includes tongue depression 56. OSA pads 59 fit on superior side of nipple 55 over cavity 60. Flanges 57 and wings 58 are set therein with a bite block 40 separating inferior and superior sides. Bite block includes some aperture or gap to allow fluid to flow from nipple into flanges when pressure is exerted from teeth or alveolar ridges. While prior art has been known to modify the shape or orientation of flanges within a pacifier, prior art is limited to relying solely on pull vectors, or sucking to pull on the device to modify the shape. In embodiments of the present invention, push vectors, such as squeezing of the lips, alveolar ridges, and pressing the tongue against the vault all may be used to cause deformation of the device so as to extend the flanges into the buccal vestibule(s). OSA pads 59 are of a thicker cross-section, as opposed to the central ceiling gap 62.

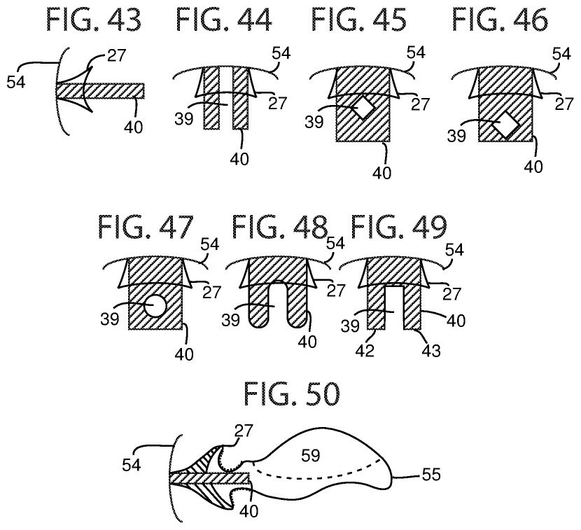

As can be seen in FIGS. 43-50, portions of pacifier embodiments, such as a bite block of preferred embodiment of the present invention are shown. Shield 54 is set on distal end while nipple extends towards proximal end. Flanges, or skirt 27, are provided and shown for reference. Bite block 40 is preferably made of a flexible yet, preferably somewhat stiffer material than nipple. In some embodiments, same material may be used for both nipple and bite block. An alternative embodiment nipple may be flexible, while bite block may be made of a much harder plastic or other material. Bite block may include right bar 42 and left bar 43 with flow channel set therebetween. In other embodiments, bite block may be made of a single form with an aperture set therein. The aperture may be of any shape, here shown as a square or circle. Furthermore, right and left bars 42 and 43 may be of any shape so long as flow channel remains therebetween.

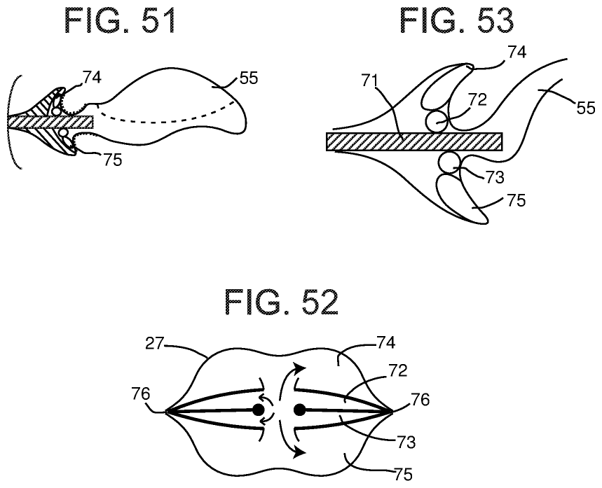

As can be seen in FIGS. 51-53, an alternative embodiment of a nipple, or bottle, is shown with articulating extending flanges. In this embodiment, multiple chambers provide for an articulating extension of the flanges to extend both upward and medially/internally towards the vestibule and alveolar ridge to facilitate and encourage contact against the teeth, and/or ridges. The flanges may expand circumferentially, and the articulating movement causes the flange to approximate the mucosa more intimately. As the first, minor, chamber is filled, overflow into the major chamber will have the effect of better approximating the flange to the angle of the alveolar ridge which inclines posteriorly/inwardly. Further, these extended flanges provide a bumper to prevent excessive pronation of the ridges/teeth beyond twenty-degrees. Bite block 40 is set between chambers and extends into nipple 55. Lips provide a push force vector from both upper and lower surfaces. While tongue provides a further push force vector upwards, forcing fluid anteriorly/forwards from cavity within nipple into chambers to extend flanges. As can be seen in FIG. 23, when nipple 55 is compressed, fluid fills into flanges including minor maxillary chamber 72, major maxillary chamber 74, minor mandibular chamber 73, and major mandibular chamber 75. It is contemplated that the minor chambers fill first, extending up and down, while the major chambers fill second, being forced to extend in the distal/internal direction, diagonally both up and down at an angle to cause intimate contact with ridges or ridges/gums (with erupted teeth). Solid portions 71 within flanges are set and do not accept moving fluids but allow for manipulation and change of form, such as balloons.

As can be seen in FIG. 52, sides 76 may provide a location wherein central chamber wall 77 meets superior chamber wall 78 and inferior chamber wall 79. Bite block 40 is shown as two separate bars. Frenum indentation is shown as both maxillary 63 and mandibular 64. As fluid is forced out of nipple and into flanges, fluid first enters minor maxillary and mandibular chambers 72 and 73 via fluid flow arrows shown. As the pressure in the minor chambers rises, fluid is then directed, due to the lower pressure in the major chambers, into the major maxillary and mandibular chambers 74 and 75, causing the flanges to fill the forward buccal vestibules. In this manner, the flanges are articulated in a step-wise fashion so as to force them to extend outward and then distally towards the vaults, or alveolar ridges.

The present invention is intended to solve the issue of hygienic problems and provide caries management. The present invention may reduce baby bottle caries. As it is known that 15% more or less of newborns have emerged teeth, caries has become a major issue. The benefits of the present invention are both health and hygiene as well as aesthetics of the development of the maxilla and mouth. By using early guidance of maxilla, one may reverse environmental trends to allow for ideal phenotypic expression of the potential genotype so as to create a healthier and more aesthetic environment. The present invention provides potential dual benefit of hygiene and orthotropics to aid/decrease the risks of OSA.

1. An oral pacification device adapted to be at least partially inserted into the oral cavity, said device comprising:
a. a bladder comprising an exterior shell and a fluid-filled chamber, the bladder forming a nipple at a posterior end and an at least first flange along an anterior end;
b. said chamber extending into said nipple and said at least first flange, a nipple interior in fluid communication with a flange interior;
c. wherein said bladder adapted to revert to a resting shape, said bladder forming a compressed state when said nipple is exposed to external compression forces wherein fluid flows from said nipple to said at least first flange, said compressed state comprising an extended at least first flange.

2. The oral pacification device as set forth in claim 1 wherein at least a portion of said shell adapted to distort with flowing fluid from said nipple to said at least one flange when bladder transforms from resting shape to compressed state.

3. The oral pacification device as set forth in claim 1 wherein said extended at least first flange comprises an articulating dual chamber expansion system, said expansion system comprising a superior minor chamber, and a superior major chamber.

4. The oral pacification device as set forth in claim 3 wherein said superior minor chamber exhibits an outwards and posterior force on said superior major chamber.

5. The oral pacification device as set forth in claim 1 comprising a superior frenum indentation within said at least first flange.

6. The oral pacification device as set forth in claim 1 further comprising a bite block set with said bladder, said bite block providing a passage allowing fluid communication as between said nipple and said flange.

7. The oral pacification device as set forth in claim 1 wherein said nipple comprises at least one OSA pad positioned along a superior surface of said nipple.

8. The oral pacification device as set forth in claim 7 wherein said nipple further comprises a second OSA pad positioned along a left superior surface of said nipple, and wherein said at least one OSA pad positioned along a right superior surface of said nipple.

9. The oral pacification device as set forth in claim 8 wherein said nipple comprises a superior cleft set between said at least one OSA pad and said second OSA pad.

10. An oral device adapted to be at least partially inserted into the oral cavity, said device comprising:
a. a nipple set along a posterior end of said oral device;
b. a tongue guide depression set along an inferior surface of said nipple;
c. a skirt coupled anterior relative said nipple, said skirt comprising at least one superior major undulation, said at least one superior major undulation adapted to expand or rotate when said nipple is exposed to external pressures.

11. The oral device as set forth in claim 10 further comprising at least one pore set along a posterior end of said nipple.

12. The oral device as set forth in claim 10 wherein said nipple comprises at least one OSA pad along a superior surface of said nipple.

13. The oral device as set forth in claim 10 wherein said nipple comprises at least a second OSA pad along a superior surface of said nipple, said at least one OSA pad and said at least a second OSA pad coupled via a superior cleft along a central superior section of said nipple.

14. The oral device as set forth in claim 10 further comprising a minor undulation set inferior said superior undulation along said skirt, said major undulation and said minor undulation forming a rib.

15. The oral device as set forth in claim 10 wherein said nipple and skirt comprises a mouth portion, and said mount portion comprising an anterior end, said mouth portion anterior end coupled to a cap.

16. The oral device as set forth in claim 15 further comprising a bottle coupled to a cap anterior end.

17. The oral device as set forth in claim 10 further comprising a neck set anterior said skirt, said neck comprising an air vent.

18. The oral device as set forth in claim 10 wherein said undulation when expanded or rotated forms an approximate maximum twenty-degree angle relative a vertical axis, or seventy-degree angle relative a horizontal plane, bisecting said device.

19. The oral device as set forth in claim 10 said skirt further comprising an inferior undulation, said inferior undulation offset at least one millimeter posterior relative said at least one superior undulation.

20. The oral device as set forth in claim 10 said device comprising a central plane bisecting said device along a right and left section, said skirt further comprising a second superior undulation, said at least one undulation set on the right section and said second superior undulation set on the left section, wherein said central plane is devoid of an undulation.

21. The oral device as set forth in claim 10 further comprising a frenum relief along a superior edge of said skirt.

22. A method for feeding from a bottle with a mouth portion set along an open end of the bottle, said method comprising:
a. at least partially inserting a passive state nipple into the oral cavity;
b. closing lips around a neck of the mouth portion;
c. pressing a tongue against a guide along an inferior side of the nipple;
d. biting down with maxillary and mandibular alveolar ridges onto a collar, the collar providing a separation between a skirt and a nipple;
e. setting the skirt at least partially into the buccal vestibule.
f. pressing at least one of the lips, the alveolar ridges, and/or the tongue against the mouth portion;
g. distorting the mouth portion to cause the skirt to open; and
h. drawing fluid from bottle out of pore in nipple.

23. The method as set forth in claim 22 further comprising the step of allowing air to enter the bottle through an air vent along the neck of the mouth portion to compensate for vacuum pressures in bottle related to said step of drawing.

24. The method as set forth in claim 22 wherein the open skirt presses against anterior sides of at least the maxillary alveolar ridge.

25. The method as forth in claim 24 wherein said open skirt is extended to open approximately twenty degrees from vertical.

26. The method as set forth in claim 22 further comprising the step of extending the nipple posteriorly during said step of distorting.

27. The method as set forth in claim 22 wherein a relative offset is formed as between the anterior-posterior location of the vertices of each of the superior and inferior skirts.

28. The method as set forth in claim 27 further comprising the step of extending the offset as between an upper skirt and a lower skirt during said step of distorting.

29. The method as set forth in claim 22 further comprising the step of causing rhythmic vibrational signaling through the skirt to at least one alveolar ridge.

30. The method as set forth in claim 22 further comprising the step of pressing OSA pads on a superior side of the nipple against a maxillary surface.
